(19) United States
(12) Patent Application Publication
(10) Pub. No.: US 2026/0088204 A1
(43) Pub. Date: Mar. 26, 2026

(54) ELECTROMAGNETIC ACTUATOR SYSTEM

(71) Applicant: Apple Inc., Cupertino, CA (US)

(72) Inventors: Christopher M. Pinciuc, Pebble Beach, CA (US); Yasin Aalipour, San Jose, CA (US); Seungbum Lim, Los Altos, CA (US); Kevin M. Robinson, Sunnyvale, CA (US); John C. DiFonzo, Redwood City, CA (US); Mitsutoshi Makihata, San Jose, CA (US); Qigen Ji, Fairfield, CA (US)

(73) Assignee: Apple Inc., Cupertino, CA (US)

(21) Appl. No.: 19/321,041

(22) Filed: Sep. 5, 2025

Related U.S. Application Data
(60) Provisional application No. 63/698,373, filed on Sep. 24, 2024.

(51) Int. Cl. H01F 7/06; H01F 7/02; H01F 7/20; H01F 27/24; H01F 27/28

(52) U.S. Cl. CPC H01F 7/064; H01F 7/0205; H01F 7/20; H01F 27/24; H01F 27/28

(57) ABSTRACT

Magnetic systems can include a controllable magnet array and a fixed magnetic array. The fixed magnetic array can include an array of permanent magnets having alternating polarization direction transverse to the array. The controllable magnet array can include controllable magnets, such as switchable permanent magnets or electromagnets, that can be selectably magnetized in a direction parallel to the polarization of the permanent magnets in the fixed magnet array or a direction antiparallel to the polarization of the permanent magnets in the fixed magnet array.

### CROSS-REFERENCE TO RELATED APPLICATION

This application claims the benefit of U.S. Provisional Application No. 63/698,373, filed Sep. 24, 2024, the disclosure of which is incorporated herein by reference.

### BACKGROUND

This disclosure relates to electrically-controlled magnetic systems and in particular to electromagnetic actuator systems that are switchable between attractive and repulsive states.

Magnetic latches can be used to hold two components in a closed position, in which opposing surfaces abut or touch each other. For example, permanent magnets can be included in the base and the lid of a laptop computer. When the lid is brought into proximity to the base, the permanent magnets can provide an attractive force to latch the lid to the base without consuming power. The attractive force can be overcome by the user pushing on the lid to open it, while making it less likely that the lid will simply fall open, e.g., while the laptop is being transported. Further, magnetic latches that lack moving parts may be more durable than mechanical latches.

However, permanent magnets can produce an external magnetic field even while the laptop is open. Thus, for instance, permanent magnets in the base that are strong enough to be effective for latching the lid may produce a strong enough field to affect or damage other nearby devices or items (such as a credit card) when the lid is open.

### SUMMARY

Certain embodiments described herein relate to electromagnetic actuator systems that can switch from an attractive to a repulsive magnetic force between components of the system. In some embodiments, the system may also have a neutral state in which little or no magnetic force is produced. An electromagnetic actuator system can include a “fixed” magnet array that includes permanent magnets having fixed magnetic polarizations and a “controllable” magnet array that includes controllable magnets, such as switchable permanent magnets or electromagnets, that can be selectably magnetized in a direction parallel to the polarization of the permanent magnets in the fixed magnet array or a direction antiparallel to the polarization of the permanent magnets in the fixed magnet array. In some embodiments, power is required only while the direction of magnetic polarity is being changed or to create short-lived magnetization states. The permanent magnets and the controllable magnets can be arranged in their respective arrays such that, depending on the state of the controllable magnets, either an attractive magnetic force or a repulsive magnetic force (or in some cases negligible magnetic force) is produced between the fixed magnet array and the controllable magnet array.

According to some embodiments, an electromagnetic actuator system can comprise: a fixed magnet array comprising an array of first permanent magnets arranged parallel to an interface surface and having fixed magnetic polarizations in alternating directions toward or away from the interface surface; a controllable magnet array comprising a plurality of electromagnets, wherein each electromagnet comprises a core made of a soft magnetic material and a coil of wire wound around the core, wherein each electromagnet of the plurality of electromagnets is positioned in alignment with a corresponding one of the first permanent magnets; and a control and driver circuit coupled to the coils and configured to supply current pulses to the coils in a first direction, thereby producing a first state of the controllable magnet array in which a direction of magnetic polarization of each electromagnet is anti-parallel to the magnetic polarization of the corresponding one of the first permanent magnets, creating magnetic repulsion between the fixed magnet array and the controllable magnet array that persists while current pulses continue to be supplied.

In these and other embodiments, the control and driver circuit cam be further configured to supply current pulses to the coils in a second direction opposite the first direction, thereby producing a second state of the controllable magnet array in which the direction of magnetic polarization of each electromagnet is parallel to the magnetic polarization of the corresponding one of the first permanent magnets, creating magnetic attraction between the fixed magnet array and the controllable magnet array.

In these and other embodiments, the control and driver circuit can be configured to supply current pulses to different coils independently of each other.

In these and other embodiments, the control and driver circuit can be further configured to modify a magnitude of a magnetic force between the fixed magnet array and the controllable magnet array by supplying current pulses to a subset of the electromagnets.

In these and other embodiments, the control and driver circuit can include gating circuitry to prevent ringing in the coils following a current pulse.

In these and other embodiments, the soft magnetic material of the cores of the electromagnets can comprise steel.

In these and other embodiments, when the control and driver circuit is not supplying current and the fixed magnet array is in proximity to the controllable magnet array, a magnetic attraction can be created between the cores of the electromagnets and the first permanent magnets of the fixed magnet array.

In these and other embodiments, the fixed magnet array can further include a plurality of second permanent magnets, each second permanent magnet disposed between adjacent first permanent magnets, the second permanent magnets having magnetic polarity oriented in a lateral direction, and the electromagnets can be spaced apart according to a spacing of the first permanent magnets.

In these and other embodiments, the fixed magnet array can further include a shunt plate disposed on a distal side of the first permanent magnets.

In these and other embodiments, the controllable magnet array can further include a first shunt plate disposed on a distal side of the electromagnets and/or a second shunt plate disposed on a proximal side of the electromagnets.

According to some embodiments, a device can comprise: a first object having a first interface surface, the first object including a controllable magnet array comprising a plurality of electromagnets arranged proximate to the first interface surface, wherein each electromagnet comprises: a core defining an axis, the core being made of a soft magnetic material; and a coil of wire wound around the core along the axis of the core; a second object having a second interface surface, the second object being positionable relative to the first object such that the second interface surface abuts the first interface surface, the second object including a fixed magnet array comprising an array of first permanent magnets arranged proximate to the second interface surface such that each first permanent magnet aligns with a corresponding one of the electromagnets of the controllable magnet array, wherein alternating first permanent magnets have fixed magnetic polarizations in opposite directions toward or away from the interface surface; and a control and driver circuit coupled to the coils of the electromagnets and configured to supply current pulses to the coils such that supplying current pulses in a first direction produces a first state of the controllable magnet array in which a direction of magnetic polarization of each electromagnet is antiparallel to the magnetic polarization of the corresponding one of the first permanent magnets, creating a repulsive magnetic force between the fixed magnet array and the controllable magnet array that persists while current pulses continue to be supplied.

In these and other embodiments, the fixed magnet array further includes a plurality of second permanent magnets, each second permanent magnet disposed between adjacent first permanent magnets, the second permanent magnets having magnetic polarity oriented in a lateral direction, and the electromagnets can be spaced apart according to a spacing of the first permanent magnets.

In these and other embodiments, the control and driver circuit can be disposed within the first object.

In these and other embodiments, the first object can be a base that includes a keyboard oriented toward the first interface surface, and the second object can be a lid that includes display oriented toward the second interface surface. The first object and the second object can be connected by a hinge such that rotational movement of the first object or the second object about the hinge moves the first and second interface surfaces toward or away from each other. In these and other embodiments, the first permanent magnets and the electromagnets can be sized and shaped such that when the controllable magnet array is in the first state, the repulsive magnetic force between the fixed magnet array and the controllable magnet array creates a gap between the lid and the base.

In these and other embodiments, the control and driver circuit can be configured such that the control and driver circuit begins supplying current pulses to produce the first state of the controllable magnet array in response to receiving a release event signal and ceases supplying current pulses in response to receiving an open event signal following the release event signal or after a maximum duration has passed.

In these and other embodiments, the control and driver circuit can be further configured to supply current pulses to the coils in a second direction opposite the first direction, thereby producing a second state of the controllable magnet array in which the direction of magnetic polarization of each electromagnet is parallel to the magnetic polarization of the corresponding one of the first permanent magnets, creating magnetic attraction between the fixed magnet array and the controllable magnet array. For instance, the control and driver circuit can be further configured such that the control and driver circuit begins supplying current pulses to produce the second state of the controllable magnet array in response to receiving a closing event signal and ceases supplying current pulses in response to receiving an closed event signal following the closing event signal or after the maximum duration has passed.

According to some embodiments, an electromagnetic actuator system can comprise: a fixed magnet array comprising an array of first permanent magnets arranged parallel to an interface surface and having fixed magnetic polarizations in alternating directions toward or away from the interface surface; a controllable magnet array comprising a plurality of switchable permanent magnets, wherein each of the switchable permanent magnets comprises a core made of a hard magnetic material and a coil of wire wound around the core along a transverse axis of the core, wherein each of the switchable permanent magnets is positioned in alignment with a corresponding one of the first permanent magnets; and a control and driver circuit coupled to the coils and configured to supply current pulses to the coils to change a magnetic polarization state of the cores of the switchable permanent magnets, thereby switching the switchable permanent magnets among a plurality of states, the plurality of states including a first state in which a direction of magnetic polarization of the core of each switchable permanent magnet is parallel to the magnetic polarization of the corresponding one of the first permanent magnets, a second state in which the direction of magnetic polarization of the core of each switchable permanent magnet is antiparallel to the magnetic polarization of the corresponding one of the first permanent magnets, and a third state in which the core of each switchable permanent magnet is demagnetized.

In these and other embodiments, the control and driver circuit can be configured to supply current pulses to different coils independently of each other.

In these and other embodiments, the control and driver circuit can be configured such that the current pulses are supplied to the coils of different ones of the switchable permanent magnets sequentially.

In these and other embodiments, the control and driver circuit can be further configured to modify a magnitude of a magnetic force between the fixed magnet array and the controllable magnet array by switching a subset of the switchable permanent magnets between the first state and the third state.

In these and other embodiments, the control and driver circuit can include gating circuitry to prevent ringing in the coils following a current pulse.

In these and other embodiments, the first permanent magnets can be made of a first hard magnetic material having a first coercivity and the cores of the switchable permanent magnets can be made of a second hard magnetic material having a second coercivity, the second coercivity being lower than the first coercivity. For example, the first hard magnetic material can be a rare-earth magnetic material, and the second hard magnetic material can be AlNiCo.

In these and other embodiments, the fixed magnet array can further include a shunt plate disposed on a distal side of the first permanent magnets.

In these and other embodiments, the controllable magnet array can further include a shunt plate disposed on a distal side of the switchable permanent magnets.

According to some embodiments, a device can comprise: a first object having a first interface surface, the first object including a controllable magnet array comprising a plurality of switchable permanent magnets arranged proximate to the first interface surface, wherein each switchable permanent magnet comprises: a core made of a hard magnetic material and having an easy axis transverse to the first interface surface; and a coil of wire wound around the core along the axis of the core, a second object having a second interface surface, the second object being positionable relative to the first object such that the second interface surface abuts the first interface surface, the second object including a fixed magnet array comprising an array of first permanent magnets arranged proximate to the second interface surface such that each first permanent magnet aligns with a corresponding one of the switchable permanent magnets of the controllable magnet array, wherein alternating first permanent magnets have fixed magnetic polarizations in opposite directions toward or away from the interface surface; and a control and driver circuit coupled to the coils of the switchable permanent magnets and configured to supply current pulses to the coils to switch a direction of magnetic polarization of the cores of the switchable permanent magnets, thereby switching the switchable permanent magnets between a first state in which a direction of magnetic polarization of the core of each switchable permanent magnet is parallel to the magnetic polarization of the corresponding one of the first permanent magnets and a second state in which the direction of magnetic polarization of the core of each switchable permanent magnet is antiparallel to the magnetic polarization of the corresponding one of the first permanent magnets.

In these and other embodiments, the fixed magnet array can further include a plurality of second permanent magnets, each second permanent magnet disposed between adjacent first permanent magnets, the second permanent magnets having magnetic polarity oriented in a lateral direction, and the switchable permanent magnets can be spaced apart according to a spacing of the first permanent magnets.

In these and other embodiments, the control and driver circuit can be disposed within the first object.

In these and other embodiments, the first object can be a base that includes a keyboard oriented toward the first interface surface, and the second object can be a lid that includes display oriented toward the second interface surface. The first object and the second object can be connected by a hinge such that rotational movement of the first object or the second object about the hinge moves the first and second interface surfaces toward or away from each other.

In these and other embodiments, the first permanent magnets and the switchable permanent magnets can be sized and shaped such that when the switchable permanent magnets are in the first state, an attractive magnetic force is produced between the fixed magnet array and the controllable magnet array that secures the lid in a closed position adjacent to the base and when the switchable permanent magnets are in the second state, a repulsive magnetic force is produced between the fixed magnet array and the controllable magnet array that creates a gap between the lid and the base.

In these and other embodiments, the control and driver circuit can be configured such that: in response to receiving a close event signal, the control and driver circuit supplies current pulses to switch the switchable permanent magnets to the first state; and in response to receiving a release event signal, the control and driver circuit supplies current pulses to switch the switchable permanent magnets to the second state.

In these and other embodiments, the control and driver circuit can be further configured such that the current pulses are supplied to the coils of different ones of the switchable permanent magnets sequentially.

In these and other embodiments, the coils of the switchable permanent magnets can be connected in series, and the control and driver circuit can be further configured such that the current pulses are supplied to the series-connected coils.

In these and other embodiments, the control and driver circuit can be further configured to supply current pulses to the coils to switch the switchable permanent magnets between either of the first state or the second state and a third state in which the core has negligible net magnetic polarization. In these and other embodiments, the control and driver circuit can be configured such that: in response to receiving a close event signal, the control and driver circuit supplies current pulses to switch the switchable permanent magnets to the first state; in response to receiving a release event signal, the control and driver circuit supplies current pulses to switch the switchable permanent magnets to the second state; and in response to receiving an open event signal, the control and driver circuit supplies current pulses to switch the switchable permanent magnets to the third state.

The following detailed description, together with the accompanying drawings, will provide a better understanding of the nature and advantages of the claimed invention.

### BRIEF DESCRIPTION OF THE DRAWINGS

FIG. 1 shows a simplified side view of a device that incorporates an electromagnetic actuator system according to some embodiments.

FIG. 2A shows a simplified perspective view of an electromagnetic actuator system according to some embodiments.

FIG. 2B shows a simplified perspective view of a switchable permanent magnet that can be used in some embodiments.

FIG. 2C shows a simplified perspective view of adjacent switchable permanent magnets in a controllable magnet array according to some embodiments.

FIG. 3 shows a simplified schematic diagram of a control and driver circuit for an electromagnetic actuator system according to some embodiments.

FIGS. 4 and 5 show flow diagrams of processes that can be implemented in a control and driver circuit for an electromagnetic actuator system according to some embodiments.

FIG. 6A shows a simplified perspective view of an electromagnetic actuator system according to some embodiments.

FIG. 6B shows a simplified top view of the controllable magnet array of the electromagnetic actuator system of FIG. 6A.

FIG. 7 shows a simplified schematic diagram of a control and driver circuit for an electromagnetic actuator system according to some embodiments.

FIGS. 8 and 9 show flow diagrams of processes that can be implemented in a control and driver circuit for an electromagnetic actuator system according to some embodiments.

FIGS. 10A and 10B show simplified side views of a device that incorporates an electromagnetic actuator system according to some embodiments.

FIG. 11 shows a simplified side view of an electromagnetic actuator system 1100 according to some embodiments.

### DETAILED DESCRIPTION

The following description of exemplary embodiments of the invention is presented for the purpose of illustration and description. It is not intended to be exhaustive or to limit the claimed invention to the precise form described, and persons skilled in the art will appreciate that many modifications and variations are possible. The embodiments have been chosen and described in order to best explain the principles of the invention and its practical applications to thereby enable others skilled in the art to best make and use the invention in various embodiments and with various modifications as are suited to the particular use contemplated.

Certain embodiments described herein relate to electromagnetic actuator systems incorporating controllable elements that can be switched between different states using current pulses. The states can include states that create attractive or repulsive magnetic forces between components of the system. In some embodiments, the controllable elements may also have a neutral state in which little or no magnetic force is produced. By switching the state, magnetic forces can be used to create attractive or repulsive or negligible forces between two objects at different times.

### Overview of Electromagnetic Actuator Systems

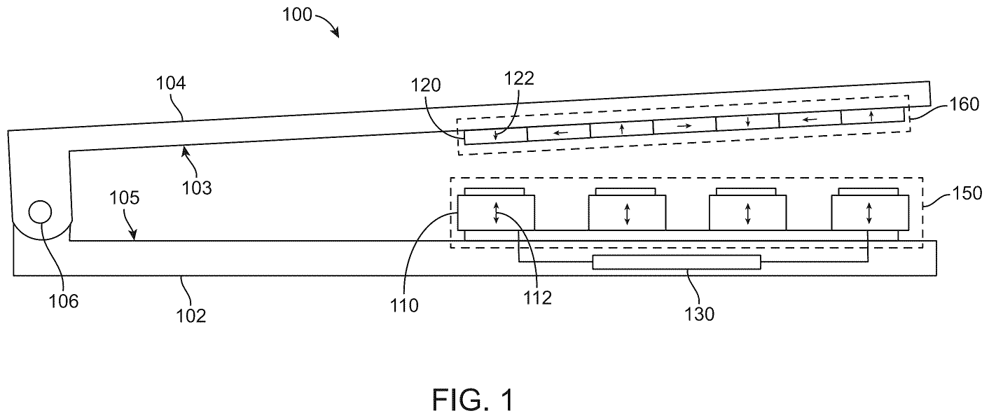

FIG. 1 shows a simplified side view of a device 100 that incorporates an electromagnetic actuator system according to some embodiments. Device 100 can be, for example, a laptop computer having a base 102 (which may include keyboard, trackpad, or the like) and a lid 104 (which may include a display, camera, and the like). Base 102 and lid 104 can be connected by a hinge 106, and lid 104 can pivot on hinge 106 between open and closed positions. It should be understood that device 100 can be any device that may be opened and closed, and that base 102 and lid 104 can correspond to any two components having opposing surfaces that are brought together (into a closed position where at least a portion of the opposing surfaces abut each other) or moved apart (into an open position).

The electromagnetic actuator system can include a “fixed” magnet array 160 and a “controllable” magnet array 150. (“Fixed” is used herein to indicate that the magnetic polarization of a magnetic element does not change direction during device operation, in contrast with a “controllable” magnet, where the polarization direction can be controllably modified.) Controllable magnet array 150 can be attached to or housed within base 102, oriented toward interface surface 103 of lid 104. Fixed magnet array 160 can be attached to or housed within lid 104, oriented toward interface surface 105 of base 102. (While the terms “base” and “lid” are used herein for purposes of illustration, it should be understood that base 102 can be any structure that incorporates a controllable magnet array of an electromagnetic actuator system, while lid 104 can be any structure that incorporates a fixed magnet array.) Controllable magnet array 150 and fixed magnet array 160 can be oriented such that they come into proximity with each other as lid 104 moves toward the closed position. Direct contact between controllable magnet array 150 and fixed magnet array 160 when in the closed position is not required; however, smaller gaps between controllable magnet array 150 and fixed magnet array 160 correspond to increased magnetic strength (if all other factors are equal). Any intervening surfaces (e.g., a housing of base 102 or lid 104) should have low magnetic permeability so that flux can pass through. For instance, a plastic cover may be disposed over either or both of controllable magnet array 150 and fixed magnet array 160 to protect and/or conceal the magnets.

According to various embodiments, fixed magnet array 160 can include permanent magnets 120 arranged with magnetic polarity in different directions. In the example shown, permanent magnets 120 are arranged in a Halbach array as indicated by arrows 122 inside permanent magnets 120. Other arrangements can also be used; examples are described below. According to various embodiments, controllable magnet array 150 can include one or more controllable magnets 110, such that each controllable magnet 110 aligns with a different one of permanent magnets 120. Controllable magnets 110 can be implemented using various configurations of magnets that can be placed into a desired magnetization state (indicated by arrows 112) by operating control circuitry 130 to apply current pulses. These magnetization states can include two or more of: an “ATTRACT” state, in which controllable magnet 110 has a magnetic orientation that attracts the corresponding permanent magnet 120; a “REPEL” state, in which controllable magnet 110 has a magnetic orientation that repels the corresponding permanent magnet 120; or an “OFF” state, in which controllable magnet 110 exerts negligible magnetic force on the corresponding permanent magnet 120. (Fo instance, controllable magnet 110 can be demagnetized, or the magnetization may decay naturally as described below.) In some embodiments, controllable magnets 110 can be implemented using switchable magnets made of a hard magnetic material. In other embodiments, controllable magnets 110 can be implemented using electromagnets with cores of a soft magnetic material (or air cores).

Various embodiments support the following operations. While lid 104 is open (e.g., during normal laptop use), control circuitry 130 does not deliver current to controllable magnets 110. Controllable magnets 110 may be in an OFF state during this time. When lid 104 is moved into or toward the closed position, control circuitry 130 can switch controllable magnet array 150 to an ATTRACT state by providing one or more current pulses to controllable magnets 110 in the direction that creates an attractive magnetic force toward fixed magnet array 160. The attractive magnetic force may help draw lid 104 into the closed position. In some embodiments, once the lid is closed, at least some degree of magnetic attraction between permanent magnets 120 and controllable magnets 110 can help to secure lid 104 in the closed position while no current pulses are applied by controllable magnets 110.

When the user initiates opening of lid 104 from the closed position (e.g., by touching a sensor on the edge of the lid or exerting upward force or the like), control circuitry 130 can switch controllable magnet array 150 to a REPEL state by providing one or more current pulses to controllable magnets 110 in the direction that creates a repulsive magnetic force toward fixed magnet array 160. This repulsive force can assist the user in lifting lid 104 or can cause lid 104 to pop open, e.g., by creating a gap between lid 104 and base 102 that may facilitate further movement of lid 104 into a desired position for operating device 100. In some embodiments, magnetic repulsion between permanent magnets 120 and controllable magnets 110 can help to maintain the gap while a user manually moves lid 104 into the desired position without additional current pulses being supplied to maintain the REPEL state.

To optimize power consumption, it may be desirable that the electromagnetic actuator system consumes power only while switching controllable magnet array 150 from one state to another; leaving controllable magnet array in a particular state (e.g., ATTRACT, OFF, or REPEL) should not require continuous power. Thus, electromagnetic actuator systems of the kind described herein can be suitable for battery-operated devices or the like.

Example implementations of electromagnetic actuator systems using switchable permanent magnets and using electromagnets will now be described.

### Electromagnetic Actuator Systems Using Switchable Permanent Magnets

In some embodiments, controllable magnets 110 can be implemented using permanent magnets whose direction of magnetization can be altered (e.g., flipped along an easy axis) by exposure to an external magnetic field. For example, controllable magnets 110 can be “switchable” permanent magnets having cores made of a hard magnetic material (with lower coercivity than the material of the permanent magnets in the fixed magnet array) and a conductive wire wrapped to form a coil around the core such that the easy axis of the hard magnetic material is oriented along the axis of the coil. Current (e.g., one or more current pulses) can be applied to the coil in one direction to establish a magnetic polarity within the core in a first axial direction (thereby placing controllable magnet 110 in an ATTRACT state), and one or more current pulses can be applied to the coil in the other direction to reverse the magnetic polarity within the core to the opposite axial direction (thereby placing controllable magnet 110 in a REPEL state). In some embodiments, current pulses can also be applied to demagnetize the core (thereby placing controllable magnet 110 in an OFF state). The permanent magnet retains its magnetization after the current pulses stop; accordingly, power is required only while the direction of magnetic polarity is being changed. In an electromagnetic actuator system, the permanent magnets and the switchable magnets can be arranged in their respective arrays such that, depending on the state of the switchable magnets, either an attractive magnetic force or a repulsive magnetic force (or in some cases negligible magnetic force) is produced between the fixed magnet array and the controllable magnet array.

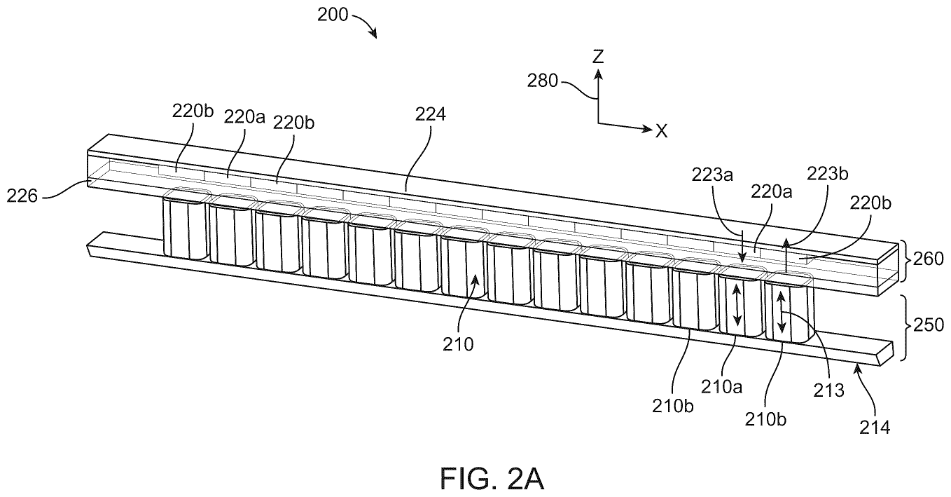

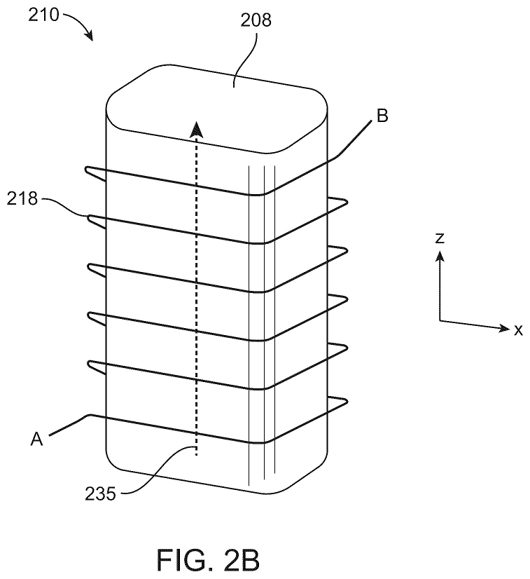

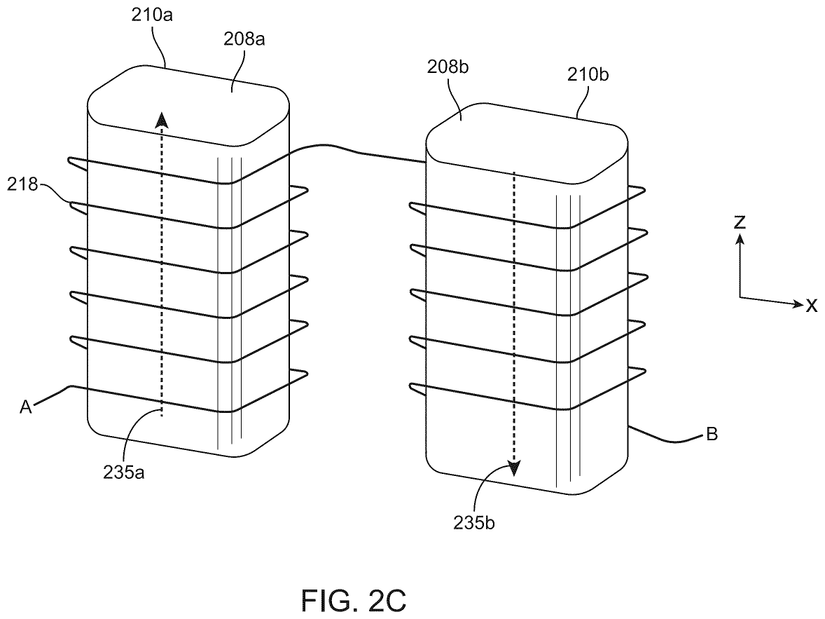

FIG. 2A shows a simplified perspective view of an electromagnetic actuator system 200 according to some embodiments. Electromagnetic actuator system 200 can be used, e.g., to implement the electromagnetic actuator system in device 100 of FIG. 1. Electromagnetic actuator system 200 includes a controllable magnet array 250 and a fixed magnet array 260. For convenience of description, a coordinate system can be defined as shown at 280 in FIG. 2A; the x-axis is sometimes referred to herein as a “longitudinal” dimension or direction, and the z-axis is sometimes referred to as “transverse” or “vertical,” with “up” corresponding to the +z direction and so on. It should be understood that all directional terms are used for convenience of description and that a particular orientation in space is not required. Controllable magnet array 250 can include an array of switchable permanent magnets 210. FIG. 2B shows a simplified perspective view of a switchable permanent magnet 210 that can be used in some embodiments. As shown in FIG. 2B, switchable permanent magnet 210 can be formed by winding a conductive coil 218 (e.g., copper wire) around a core 208. Core 208 can be made of a permanent (or hard) magnetic material having low coercivity, such as an aluminum-nickel-cobalt material (AlNiCo), oriented such that the easy axis of the magnetic material is aligned parallel to the z axis. Coil 218 can be wound such that the axis of coil 218 is aligned with (e.g., parallel to) the easy axis of the magnetic material. When current passes through coil 218 in a direction from A to B, magnetic flux oriented in the +z direction is created in core 208 (indicated by large dashed arrow 235), which can magnetize core 208 in the +z direction; when current passes through coil 218 in a direction from B to A, a magnetic field oriented in the −z direction is created in core 208, which can magnetize core 208 in the −z direction. Use of a hard magnetic material for core 208 can allow core 208 of switchable permanent magnet 210 to retain a magnetic orientation after the current pulses end; accordingly, current pulses are only needed when the magnetic orientation is to be switched. Further, the low coercivity of core 208 reduces the amount of current required to switch the magnetic orientation. In some embodiments, current pulses can also be used to demagnetize core 208; examples are described below.

Referring again to FIG. 2A, switchable permanent magnets 210 in controllable magnet array 250 can be arranged so that their easy axis is oriented in the vertical (or z) direction, as indicated by double-ended arrows 213. In some embodiments, a single length of wire can be wound around the cores of all switchable permanent magnets 210, and adjacent switchable permanent magnets 210 can have their coils wound in opposite directions. FIG. 2C shows a simplified perspective view of adjacent switchable permanent magnets 210a, 210b according to some embodiments. As shown, when current flows through coil 218 in the direction from A to B, magnetic flux oriented in the +z direction is created in core 208a of switchable permanent magnet 210a, as indicated by arrow 235a, while magnetic flux oriented in the −z direction is created in core 208b of adjacent switchable permanent magnet 210b, as indicated by arrow 235b. Those skilled in the art will appreciate that alternating directions of flux in adjacent switchable magnets can be achieved in a variety of ways, and that it is not necessary for the coils of different switchable magnets to be connected in series.

Referring again to FIG. 2A, controllable magnet array 250 can also include a magnetic shunt 214 disposed along the distal ends of switchable permanent magnets 210 (i.e., the ends farther from fixed magnet array 260). Magnetic shunt 214 can be made of a soft magnetic material that acts as a magnetic shunt to direct flux longitudinally, such as steel, iron-cobalt (FeCo), or other material.

Fixed magnet array 260 can include an array of magnets 220, arranged such that adjacent magnets 220a, 220b have magnetic polarity in opposite directions along the z axis, as indicated by arrows 223a (showing that magnets 220a have magnetic polarity oriented in the −z direction) and 223b (showing that magnets 220b have magnetic polarity oriented in the +z direction). Magnets 220 can be made of hard magnetic materials with high coercivity that can retain their magnetic polarization regardless of changes in the polarization of controllable magnet array 250. For example, magnets 220 can be made of a rare-earth magnetic material such as neodymium-iron-boron (NdFeB) magnets or the like. A support plate 224 can be disposed along the distal side of magnets 220. Support plate 224 can be made of a soft magnetic material that acts to direct flux longitudinally; examples include steel, iron-cobalt (FeCo), or other material. If desired, spacers 226 can be disposed around fixed magnet array 260 and/or controllable magnet array 250. Spacers 226 can be made of aluminum or other material that is transparent to magnetic fields.

In operation, when one or more current pulses are applied to coils 218 of switchable permanent magnets 210 in a first direction, the magnetic flux in switchable permanent magnets 210a becomes oriented in the −z direction while the magnetic flux in switchable permanent magnets 210b becomes oriented in the +z direction, producing an attractive magnetic force between controllable magnet array 250 and fixed magnet array 260. When the current pulses stop, the hard magnetic material of cores 208 of switchable permanent magnets 210 can retain the magnetic orientation, and an attractive magnetic force can persist between switchable permanent magnets 210 and permanent magnets 220. Conversely, when one or more current pulses are applied to coils 218 of switchable permanent magnets 210 in a second direction (opposite to the first direction), the magnetic flux in switchable permanent magnets 210a can be reoriented into the +z direction while the magnetic flux in switchable permanent magnets 210b is reoriented into the −z direction, producing a repulsive magnetic force between controllable magnet array 250 and fixed magnet array 260. When the current stops, the magnetic material of cores 208 can retain the magnetic orientation (assuming that fixed magnet array 260 is pushed away by some distance) so that fixed magnet array 260 is not attracted back to controllable magnet array 250. Thus, controllable magnet array 250 can have an “ATTRACT” state and a “REPEL” state. In some embodiments, controllable magnet array 250 can also have an “OFF” state, in which it neither attracts nor repels. For example, starting from either the ATTRACT or REPEL state, an OFF state of negligible net magnetization of cores 208 can be established by applying a current pulse (or pulses) of sufficient intensity to demagnetize cores 208 without remagnetizing cores 208 into the opposite direction. In some embodiments, the attractive or repulsive force can be modified, e.g., by selectively applying current pulses to a subset of cores 208. It should be noted that controllable magnet array 250 can be operated using pulsed current, with current pulses being applied to switch switchable permanent magnets 210 from one state to another, while current is not needed to maintain a state. In some embodiments, multiple current pulses (e.g., two or three pulses) may be applied to effect a complete transition from the ATTRACT state to the REPEL state, with fewer current pulses providing an intermediate OFF state.

It will be appreciated that electromagnetic actuator system 200 is illustrative and that variations and modifications are possible. The dimensions and shape of the switchable magnets and the number of switchable magnets in the controllable magnet array can be modified as desired. The particular materials used can also be varied. For instance, any permanent (or hard) magnetic material can be used. Using materials with lower coercivity (such as AlNiCo) reduces the amount of current required to switch the direction of magnetization as compared to using materials with higher coercivity (such as NdFeB), which can result in reduced power consumption. In some embodiments the coils of different switchable magnets are connected in series (with alternating winding directions as described above). Alternatively, different switchable magnets or subsets of the switchable magnets can have separately driven coils. In such embodiments, the magnitude of attractive or repulsive force can be modified by driving different subsets of (or all of) the coils.

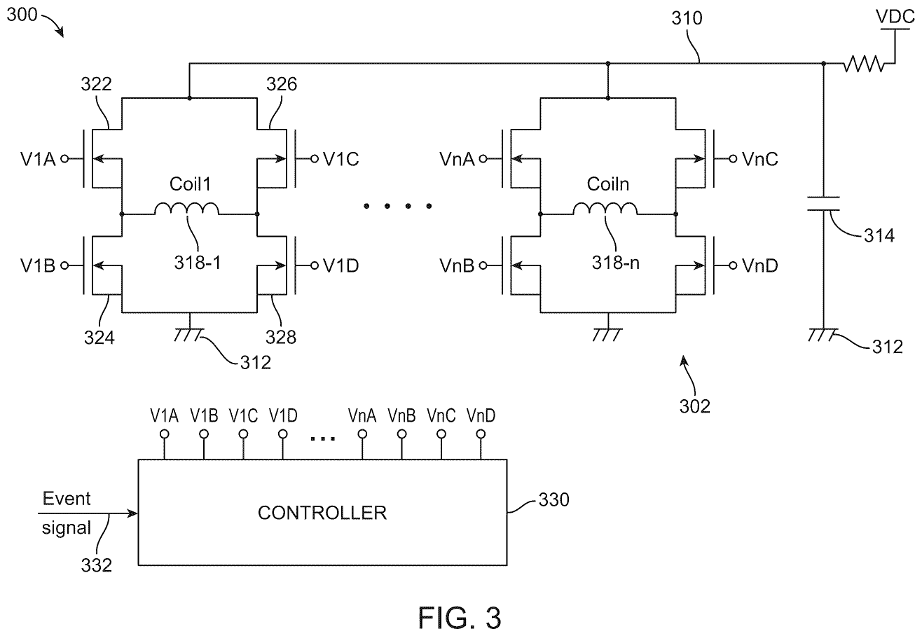

In various embodiments, magnetic actuator system can be controlled using control and driver circuitry in which the coil in each switchable permanent magnet 210 can be independently pulsed. FIG. 3 shows a simplified schematic diagram of a control and driver circuit 300 according to some embodiments. Control and driver circuit 300 can be used to drive a controllable magnet array such as controllable magnet array 250. (For instance, control and driver circuit 300 can implement control circuitry 130 of FIG. 1.) Control and driver circuit 300 can include a driver section 302 that can selectively drive pulses to one or more of a number (n) of coils 318-1 through 318-n. Each coil 318 can be a coil wound around the core of a different switchable permanent magnet 210 in controllable magnet array 250. Driver section 302 can be constructed using an H-bridge for each coil 318. For instance, as shown for coil 318-1, transistors 322 and 324 are coupled in series between an input voltage and ground. In parallel, transistors 326 and 328 are coupled in series between the input voltage and ground. One end of coil 318-1 is coupled between transistors 322 and 324 as shown, while the other end of coil 318-1 is coupled between transistors 326 and 328. By applying a first pattern of voltages to gates V1A, V1B, V1C, and V1D, transistors 322 and 328 can be switched on while transistors 324 and 326 are switched off, allowing current to flow in one direction through coil 318-1. By applying a second pattern of voltages to gates V1A, V1B, V1C, V1D, transistors 322 and 328 can be switched off while transistors 324 and 326 are switched on, allowing current to flow in the other direction through coil 318-1. When all transistors 322, 324, 326, 328 are switched off, no current flows through coil 318-1. The H-bridge arrangement also provides gating circuitry that can prevent ringing in coil 318-1 following a current pulse. A similar H-bridge arrangement of transistors can be provided for each coil 318-2 through 318-n. Since gate voltages are provided separately to each transistor, pulses can be supplied to each coil independently of any other coil. Capacitor 314 can be provided to create a current surge, allowing narrower pulses and/or higher peak current for a given amount of power.

Control and driver circuit 300 can also include a controller 330, which can be implemented using a programmable microcontroller, FPGA, ASIC, or the like. Controller 330 can have an input path 332 coupled to receive event signals. Event signals can indicate, for instance, that the controllable magnet array should be switched from one state to another state (e.g., from ATTRACT to OFF, OFF to REPEL, REPEL to ATTRACT, etc.). Responsive to the event signals, controller 330 can output voltages V1A, V1B, V1C, V1D to the gates of transistors 322, 324, 326, 328 to drive current (or not) in coil 318-1, and similarly for each other coil 318. In this example, controller 330 can drive the gate voltage of each transistor separately. Patterns or sequences of changes to voltages output by controller 330 can be defined to optimize state transitions in a controllable magnet array. For instance, multiple current pulses can be applied, and the number of pulses may depend on the state transition (e.g., a transition from ATTRACT to OFF may use fewer current pulses than a transition from ATTRACT to REPEL). As another example, each coil in a controllable magnet array (or subsets of the coils) can receive a current pulse in turn. Sequential pulsing of the coils may reduce peak power consumption as compared to parallel pulsing of all coils. Multiple current pulses can be applied to a given coil, and the number of pulses may depend on the state transition (e.g., a transition from ATTRACT to OFF may use fewer current pulses than a transition from ATTRACT to REPEL). In general, controller 330 can control the number, duration, and direction of pulses associated with a given state transition. In some embodiments, a small number of current pulses (e.g., one pulse, two pulses, or five or fewer pulses) can be applied to change the magnetization state of the switchable magnets, and current need not be supplied to maintain the magnetization state of the switchable magnets. Those skilled in the art will appreciate that peak current in coil 318 is the critical parameter for changing direction of magnetic polarization of a magnetic core and that the particular current required depends on the coil design (e.g., number of turns) and the geometry of the magnetic core. In some embodiments, pulse duration can be short (e.g., 10 to 100 microseconds). Shorter pulses allow faster switching between states; however, very short pulses may create eddy currents that can reduce the resultant magnetization in the core.

Using control and driver circuit 300, the total time to establish a desired state in the controllable magnet array between states after receiving an event signal depends on various considerations, including the duration of a current pulse and the time between current pulses. In some embodiments, the total time can be a millisecond or less, short enough that a user would not perceive the response as delayed.

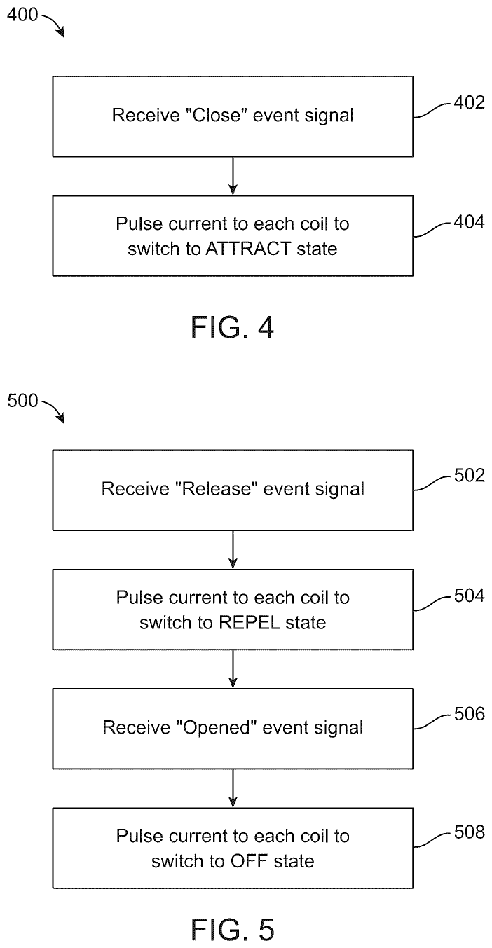

Further illustrating operation of control and driver circuit 300, FIGS. 4 and 5 show flow diagrams of processes that can be implemented in controller 330 according to some embodiments. For clarity of description, it is assumed that electromagnetic actuator system 200 is being used to implement the electromagnetic actuator system of device 100 of FIG. 1.

FIG. 4 shows a flow diagram of a process 400 that controller 330 can execute in response to an event signal that indicates a transition to the closed state according to some embodiments.

At block 402, controller 330 can receive an event signal (e.g., via input path 332 of FIG. 3) indicating that lid 104 is being closed. Depending on implementation and the particulars of device 100, a “Close” event signal can be generated under various conditions. For example, a force or acceleration sensor in lid 104 can detect movement toward the closed position, or the user may operate a control (e.g., press a button, touch a particular surface, or issue a voice command) to indicate that lid 104 should be closed or that the magnetic latch should be engaged. In some embodiments, a “Close” event signal may be generated during initial power-up of device 100 to initialize the electromagnetic actuator system into a known state.

At block 404, controller 330 can operate driver section 302 to pulse current through each coil in controllable magnet array 250 to drive controllable magnet array 250 to the ATTRACT state. For instance, controller 330 can deliver current pulses through the coils by applying appropriate voltages on the gates of the transistors coupled to that coil, as described above. In some embodiments, the voltages can be controlled so that one coil at a time receives a current pulse. The result of block 404 can be that controllable magnet array 250 exerts an attractive force on fixed magnet array 260; since cores 208 are permanent magnets, the attractive force can persist after the current pulses end. Thus, lid 104 can be drawn toward or held in a closed position adjacent to (e.g., such that at least a portion of lid 104 abuts) base 102.

FIG. 5 shows a flow diagram of a process 500 that controller 330 can execute in response to an event signal that indicates a transition to the open state according to some embodiments.

At block 502, controller 330 can receive a “Release” event signal (e.g., via input path 332 of FIG. 3) indicating that the magnetic latch should be released. Depending on implementation and the particulars of device 100, a “Release” event signal can be generated under various conditions. For example, a force or acceleration sensor in lid 104 can detect movement away from the closed position, or the user may operate a control (e.g., press a button, touch a particular surface, or issue a voice command) to indicate that lid 104 should be opened or that the magnetic latch should be released (or disengaged). In some embodiments, the state machine in the component that generates event signals can be designed such that a “Release” event signal is generated only if the preceding event signal was a “Close”signal.

At block 504, controller 330 can operate driver section 302 to pulse current through each coil in controllable magnet array 250 to drive controllable magnet array 250 to the REPEL state. For instance, controller 330 can deliver current pulses through the coils by applying appropriate voltages on the gates of the transistors coupled to that coil, as described above. In some embodiments where coils are independently controlled (e.g., using control and driver circuit 300 of FIG. 3), the voltages can be controlled so that one coil at a time receives a current pulse. The result of block 504 can be that controllable magnet array 250 exerts a repulsive force on fixed magnet array 260; the force can be strong enough to create a physical separation (e.g., 0.25 to 0.5 cm at the outer edge) between base 102 and lid 104. Since cores 208 are permanent magnets, the repulsive force can persist after the current pulses end. Once a physical separation has been created, the user (or an electrical or mechanical element that applies additional force) can further open lid 104.

In some embodiments, it may not be desirable to leave controllable magnet array 250 in the REPEL state (or the ATTRACT state) while lid 104 is open. For instance, controllable magnet array 250 may generate enough external flux in the REPEL state (or the ATTRACT state) to interfere with or affect nearby devices or objects (e.g., credit cards) while lid 104 is open. Accordingly, at block 506, controller 330 can receive an “Opened” event signal, indicating that lid 104 has been opened to a sufficient degree that the magnetic repulsion between controllable magnet array 250 and fixed magnet array 260 is no longer contributing to further opening of lid 104. In response to the “Opened” event signal, at block 508, controller 330 can pulse current through each coil in controllable magnet array 250 to drive controllable magnet array 250 to the OFF state. Once controllable magnet array 250 is in the OFF state, further current is not needed until the next event that triggers a state change.

In various embodiments, other events can be used to trigger switching of controllable magnet array 250 to the OFF state, in addition to or instead of the “Opened” event signal at block 506. For example, a timer can be used. The timer can start, e.g., when controller 330 completes block 504 of process 500 and can expire after a prescribed time (e.g., five seconds, twenty seconds, or the like), after which controller 330 proceeds to block 508.

It should be understood that processes 400 and 500 are illustrative and that variations and modifications are possible. In some embodiments, controller 330 can sequence the current pulses such that a current pulse is supplied to only one switchable permanent magnet 210 at a time (or to different subsets of the switchable magnets at different times). Such configurations may provide a more gradual transition from attraction to repulsion (or vice versa).

In processes 400 and 500, controller 330 does not need to determine the state of any switchable permanent magnet 210 prior to applying the current pulse(s); the current pulses can be of sufficient magnitude to switch the magnetic polarization of cores 208 of switchable permanent magnets 210 to the desired orientation without regard to the orientation direction prior to the pulse. If a particular switchable permanent magnet 210 is already in the desired orientation, the current pulse will have negligible effect. If desired, controller 330 can track the current magnetization state of switchable permanent magnets 210 and adjust the current pulse accordingly; however, additional power may be required to maintain and/or update stored state information, and net power savings may be negligible or nonexistent.

The particular event signals and order thereof are also illustrative. Any number and combination of event signals can be defined, and controller 330 can be configured (e.g., using programming or logic circuitry) to generate appropriate current pulses for the state transition associated with a particular event. The conditions that trigger sending of event signals to controller 330 can be defined in any manner desired without departing from the scope of this disclosure.

In some embodiments, it may not be desirable to leave the magnetic latch disengaged for a prolonged period in the absence of user activity. For example, after executing block 504 of process 500, controller 330 may wait for the “Opened” event signal at block 506 for a prescribed timeout period (e.g., ten seconds, thirty seconds, two minutes). If no “Opened” event signal is received within the timeout period, controller 330 can re-engage the magnetic latch, e.g., by executing block 404 of process 400. Other combinations and sequences of events can also be supported.

Other variations are also possible. For example, it may be desirable to exert different amounts of attractive or repulsive force at different times. In some embodiments, this can be achieved by switching some but not of switchable permanent magnets 210 to a different state. For example, a “full-force” attraction state can be defined as a state with all switchable permanent magnets 210 in the ATTRACT state, and a “half-force” attraction state can be defined as a state with half of switchable permanent magnets 210 in the ATTRACT state and the other half of switchable permanent magnets 210 in the OFF state. In a similar manner, full-force repulsion and half-force repulsion states can also be created. Event signals to controller 330 can indicate which state should be entered, and controller 330 can generate the appropriate sequence of current pulses to establish a particular state in response to a particular event signal. (For instance, appropriate sequences for different states can be stored in a lookup table in association with the corresponding event signal.)

If desired, controller 330 can include an output signal path that can return information about the current state of the electromagnetic actuator system to other system components. For instance, controller 330 can send output signals indicating the state of controllable magnet array 250 (e.g., ATTRACT/REPEL/OFF) based on the most recently delivered current pulse(s) to each switchable permanent magnet 210. Such information can be used, e.g., to activate or deactivate indicator lights, to generate notification messages, to enable various security features, or the like.

### Electromagnets With Soft Magnetic Cores

Referring again to FIG. 1, in some embodiments, controllable magnets 110 can be implemented using electromagnets having cores made of soft magnetic material and a conductive wire wrapped to form a coil around the core. One or more current pulses can be applied to the coils in one direction to transiently create a magnetic polarity in a first axial direction (thereby placing controllable magnet 110 in a REPEL state). When current stops flowing, the magnetic polarity of the soft magnetic material of the core decays to zero (thereby placing controllable magnet 110 an OFF state). In some embodiments, one or more current pulses can be applied to the coil in the other direction to transiently create a magnetic polarity in the opposite axial direction (thereby placing controllable magnet 110 in an active ATTRACT state). In an electromagnetic actuator system, the permanent magnets and the electromagnets can be arranged in their respective arrays such that, depending on the state of the electromagnets, an attractive magnetic force or a repulsive magnetic force is produced between the fixed magnet array and the controllable magnet array. It should be noted that if no current is flowing in the electromagnets and the fixed magnet array is in proximity to the controllable magnet array, a magnetic attraction can passively arise between the permanent magnets of the fixed magnet array and the soft magnetic cores of the electromagnets. This passive magnetic attraction can hold lid 104 in the closed position without requiring current to be applied to the coils, and in some embodiments an active ATTRACT state need not be used.

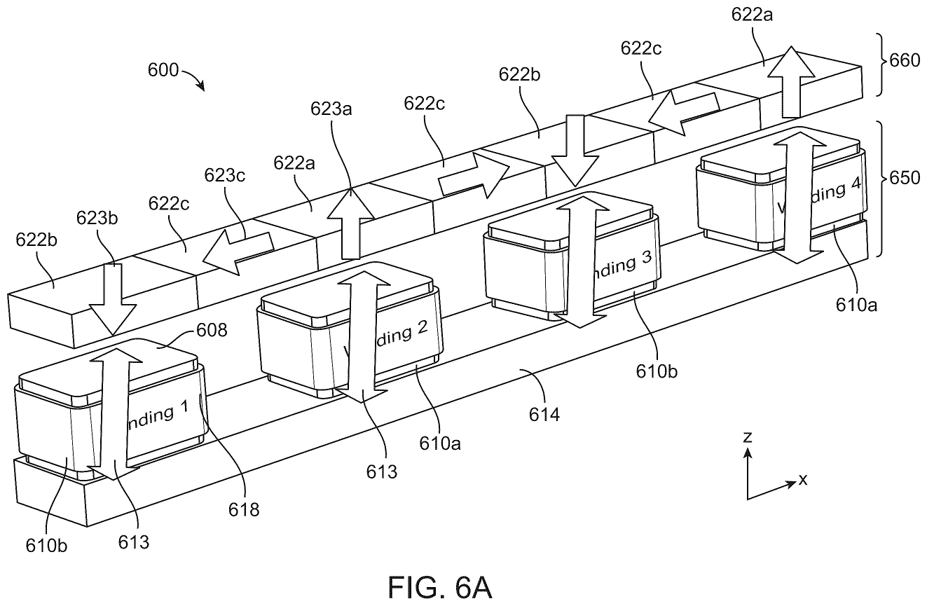

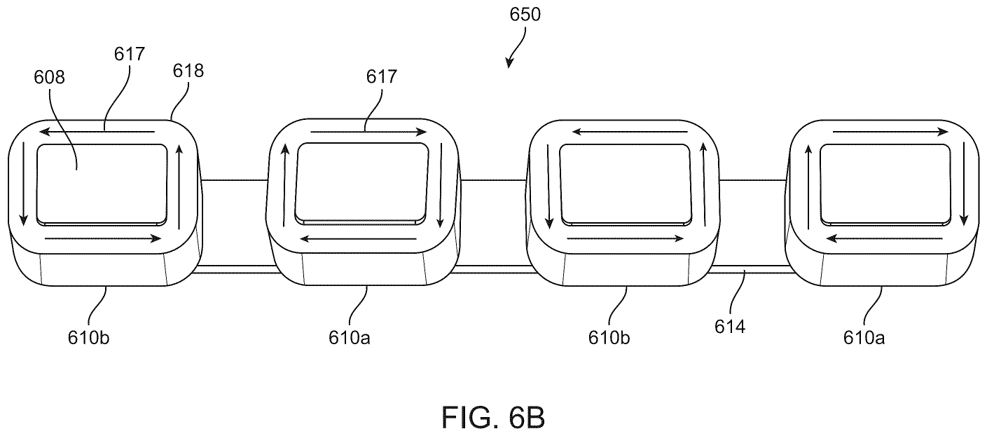

FIG. 6A shows a simplified perspective view of an electromagnetic actuator system 600 according to some embodiments. Electromagnetic actuator system 200 can be used, e.g., to implement the electromagnetic actuator system in device 100 of FIG. 1. Electromagnetic actuator system 600 includes a controllable magnet array 650 and a fixed magnet array 660. Controllable magnet array 650 can include an array of electromagnets 610 arranged so that their polarization is oriented in the vertical (or z) direction, as indicated by double-ended arrows 613. Electromagnets 610 can include a core 608 made of a soft magnetic material such as 1010 steel or FeCo, around which a coil 618 is wound. Adjacent electromagnets 610 can have their coils wound to provide alternating directions of magnetic flux, such that when electromagnets 610a produces magnetic flux in the +z direction, electromagnets 610b produce magnetic flux in the −z direction and vice versa. FIG. 6B shows a simplified top view of controllable magnet array 650, showing cores 608 and coils 618; arrows 617 indicate the opposing circulation of currents in coils 618 of adjacent electromagnets 610. Controllable magnet array 650 can also include a magnetic shunt 614 disposed along the distal ends of electromagnets 610. Magnetic shunt 614 can be made of a soft magnetic material that acts to direct flux in a lateral direction (e.g., the x direction); examples of suitable materials include steel, iron-cobalt (FeCo), or other material.

Referring again to FIG. 6A, fixed magnet array 660 can include an array of permanent magnets 622 (which can be rare earth magnets or other permanent magnets having high coercivity), arranged to form a Halbach array. For instance, permanent magnets 622a can have magnetic polarity oriented in the +z direction, as indicated by arrows 623a; permanent magnets 622b can have magnetic polarity oriented in the −z direction, as indicated by arrows 623b; and permanent magnets 622c can have magnetic polarity oriented in the lateral (x) direction, as indicated by arrows 623c. Permanent magnets 622c create space and provide a lateral flux path between permanent magnets 622a and 622b, and the spacing of electromagnets 610 in controllable magnet array 650 can be chosen such that each electromagnet 610a aligns (in the x direction) with a permanent magnet 622a while each electromagnet 610b aligns (in the x direction) with a permanent magnet 622b. If desired, additional spacers (not shown in FIG. 6A) can be disposed around fixed magnet array 660 and/or controllable magnet array 650. Like spacers 226 described above, such spacers can be made of aluminum or other material that is generally transparent to magnetic fields.

In operation, when current is applied to coils 618 of electromagnets 610 in a first direction, the magnetic flux in electromagnets 610b becomes oriented in the +z direction while the magnetic flux in electromagnets 610a becomes oriented in the −z direction, producing a repulsive magnetic force between controllable magnet array 650 and fixed magnet array 660. When the current stops, the soft magnetic material of cores 608 of electromagnets 610 generally does not retain its magnetic orientation, and the repulsive force drops to zero (or near zero). Conversely, when current is applied to coils 618 of electromagnets 610 in a second direction (opposite to the first direction), the magnetic flux in electromagnets 610b becomes oriented in the −z direction while the magnetic flux in electromagnets 610a becomes oriented in the +z direction, producing an attractive magnetic force between controllable magnet array 650 and fixed magnet array 660. Again, when the current stops, the soft magnetic material of cores 608 generally does not retain its magnetic orientation, and the attractive force drops to zero (or near zero). Thus, controllable magnet array 650 can have a “REPEL” state, an “ATTRACT” state, and an “OFF” state. In this case, the REPEL and ATTRACT states can be transitory states that persist while current is supplied, with controllable magnet array 650 relaxing to the OFF state when current stops. In some embodiments, the current can be a pulsed current, and multiple current pulses can be supplied to maintain a REPEL or ATTRACT state.

When controllable magnet array 650 is in the OFF state, it is possible for nearby permanent magnets to induce magnetization in the soft magnetic cores of electromagnets 610. In particular, if fixed magnet array 660 is in proximity to controllable magnet array 650 while controllable magnet array 650 is in the OFF state, the permanent magnets of the fixed magnet array can magnetize the soft magnetic cores of electromagnets 610 such that an attractive magnetic force is created between fixed magnet array 660 and controllable magnet array 650. This condition, referred to herein as a passive attraction, or “P-ATTRACT,” state, arises passively (without supplying any current to controllable magnet array 650) and can, for example, help to secure lid 104 in the closed position without requiring any current to be supplied to controllable magnet array 650. In some embodiments, the P-ATTRACT state provides attractive force when desired, and an active ATTRACT state need not be implemented.

It will be appreciated that electromagnetic actuator system 600 is illustrative and that variations and modifications are possible. The dimensions and shape of the electromagnets and the number and spacing of electromagnets in a controllable magnet array can be modified as desired. In some embodiments, the electromagnets can include air-core electromagnets. (It should be noted that air-core electromagnets would not provide a passive attraction state.) For a given coil geometry and current, an air-core electromagnet generally produces a weaker magnetic field; however, eliminating the magnetic cores can reduce weight, which may be a desirable tradeoff for ultra-light devices. In some embodiments the coils of different electromagnets are connected in series (with alternating winding directions as described above). Alternatively, different electromagnets or subsets of the electromagnets can have separately driven coils. In such embodiments, the magnitude of attractive or repulsive force can be modified by driving different subsets of (or all of) the coils.

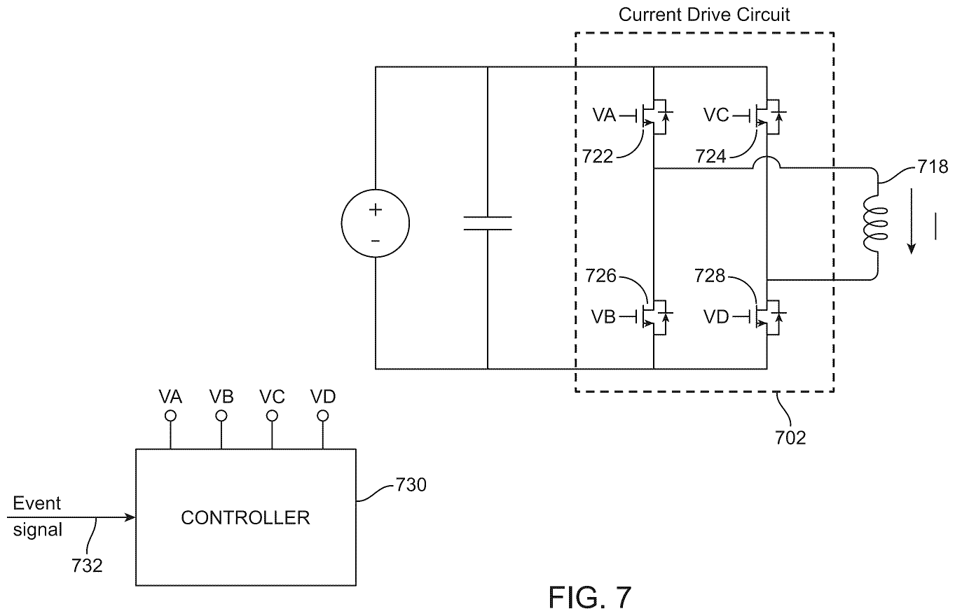

In various embodiments, electromagnetic actuator system 600 can be controlled using control and driver circuitry to provide current pulses to electromagnets 610. FIG. 7 shows a simplified schematic diagram of a control and driver circuit 700 according to some embodiments. Control and driver circuit 700 can be used to drive a controllable magnet array such as controllable magnet array 650. (For instance, control and driver circuit 300 can implement control circuitry 130 of FIG. 1.) Control and driver circuit 700 can include a driver section 702 that can selectively drive current pulses in either direction to a coil 718, which can include the serially-coupled coils of all electromagnets 610 in controllable magnet array 650. Driver section 702 can be constructed using an H-bridge, with transistors 722 and 724 coupled in series between a high and low voltage, while in parallel, transistors 726 and 728 are coupled in series between the high and low voltage. One end of coil 718 is coupled between transistors 722 and 724 as shown, while the other end of coil 718 is coupled between transistors 726 and 728. By applying a first pattern of voltages to gates VA, VB, VC, and VD, transistors 722 and 728 can be switched on while transistors 724 and 726 are switched off, allowing current to flow in one direction through coil 718. By applying a second pattern of voltages to gates VA, VB, VC, VD, transistors 722 and 728 can be switched off while transistors 724 and 726 are switched on, allowing current to flow in the other direction through coil 718. When all transistors 722, 724, 726, 728 are switched off, no current flows through coil 718. The H-bridge arrangement also provides gating circuitry that can prevent ringing in coil 718 following a current pulse.

Control and driver circuit 700 can also include a controller 730, which can be implemented using a programmable microcontroller, FPGA, ASIC, or the like. Controller 730 can have an input path 732 coupled to receive event signals. Event signals can indicate, for instance, that the controllable magnet array should be driven into a particular state (e.g., REPEL, OFF, or ATTRACT). Responsive to the event signals, controller 730 can output voltages VA, VB, VC, VD to the gates of transistors 722, 724, 726, 728 to drive current (or not) in coil 718. In this example, controller 730 can drive the gate voltage of each transistor separately. Patterns or sequences of changes to voltages output by controller 730 can be defined to optimize state transitions in a controllable magnet array. For instance, one or more current pulses can be applied, and the number of pulses may depend on the desired state. In general, controller 730 can control the number, duration, and direction of pulses associated with a given state. In some embodiments, a current pulse can be applied to establish the REPEL state (or the ATTRACT state) for a short duration (e.g., one to five seconds), and the electromagnets can be in the OFF state at other times. In general, controller 730 can control the number, duration, and direction of pulses associated with a given state. In some embodiments, pulse duration can be short (e.g., 10 to 100 microseconds). Shorter pulses allow faster response to state activation; however, very short pulses may create eddy currents that can reduce the resultant magnetization.

Using control and driver circuit 700, the total time to establish a desired REPEL (or ATTRACT) state in the controllable magnet array between states after receiving an event signal depends on various considerations, including the duration of a current pulse and the time between current pulses. In some embodiments, the total time can be a millisecond or less, short enough that a user would not perceive the response as delayed. In some embodiments, control and driver circuit 700 generates current pulses while the REPEL (or ATTRACT) state persists; cessation of current pulses results in a transition to the OFF state. It should be understood that after transition to the OFF state, the P-ATTRACT state can arise passively as described above.

If desired, control and driver circuit 700 can be modified to drive coils of different electromagnets separately (e.g., using circuitry similar to control and driver circuit 300 described above). For instance, each coil in a controllable magnet array (or subsets of the coils) can receive a current pulse in turn. Sequential pulsing of the coils may reduce peak power consumption as compared to parallel pulsing of all coils.

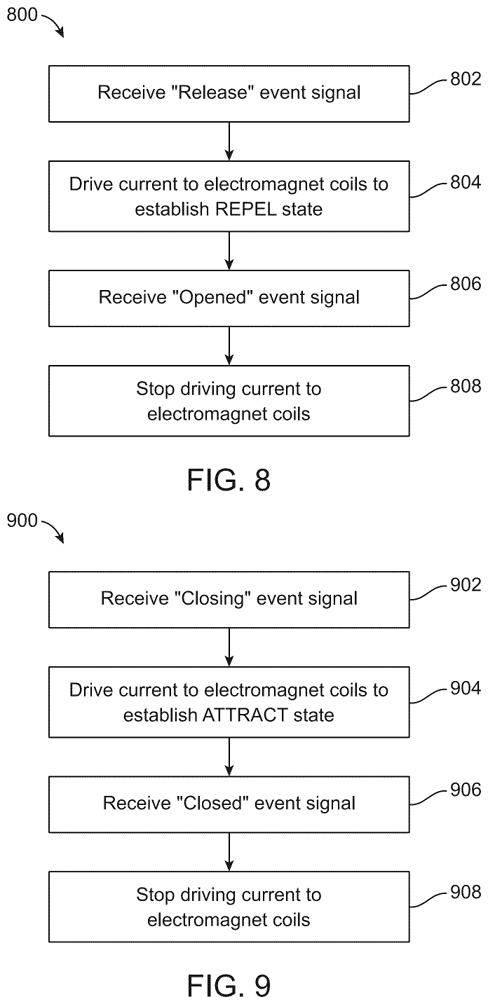

Further illustrating operation of control and driver circuit 700, FIGS. 8 and 9 show flow diagrams of processes that can be implemented in controller 730 according to some embodiments. For clarity of description, it is assumed that electromagnetic actuator system 600 is being used to implement the electromagnetic actuator system of device 100 of FIG. 1.

FIG. 8 shows a flow diagram of a process 800 that controller 730 can execute in response to an event signal that indicates a transition to the open state according to some embodiments.

At block 802, controller 730 can receive a “Release” event signal (e.g., via input path 732 of FIG. 7) indicating that lid 104 should be opened. Depending on implementation and the particulars of device 100, a “Release”event signal can be generated under various conditions. For example, a force or acceleration sensor in lid 104 can detect movement away from the closed position, or the user may operate a control (e.g., press a button, touch a particular surface, or issue a voice command) to indicate that lid 104 should be opened or that the magnetic latch should be released (or disengaged). In some embodiments, the state machine in the component that generates event signals can be designed such that a “Release” event signal is generated only if the preceding event signal was a “Closing” or “Closed” signal or if lid 104 is otherwise determined to be in the closed position.

At block 804, controller 730 can operate driver section 702 to pulse current through each coil in controllable magnet array 650 to establish the REPEL state of electromagnets 610. For instance, controller 730 can deliver one or more current pulses through the coils by applying appropriate voltages on the gates of the transistors coupled to that coil, as described above. The result of block 804 can be that controllable magnet array 650 exerts a repulsive force on fixed magnet array 660 for as long as the current pulses continue. The force can be strong enough to create a physical separation (e.g., 0.25 to 0.5 cm at the outer edge) between base 102 and lid 104. The repulsive force can persist as long as the current pulses continue. Once a physical separation has been created, the user (or an electrical or mechanical element that applies additional force) can further open lid 104.

At block 806, controller 730 can receive an “Opened” event signal, indicating that lid 104 has been opened to a sufficient degree that the magnetic repulsion between controllable magnet array 650 and fixed magnet array 660 is no longer contributing to further opening of lid 104. In response to the “Opened” event signal, at block 808, controller 730 can stop operating driver section 702 so that current ceases to flow through the coils in controllable magnet array 650, and controllable magnet array 650 returns to the OFF state. In some embodiments, to facilitate power conservation, the REPEL state can have a maximum duration, and controller 730 can proceed to block 808 when the maximum duration is reached in the absence of an “Opened” event signal. The maximum duration can be a design parameter and can be, e.g., 2 seconds, 5seconds, 10 seconds, 1 minute or other duration as desired.

In some embodiments, closing of lid 104 can be performed without actively operating controllable magnet array 650. For example, once lid 104 is opened and controllable magnet array 650 returns to the OFF state, the magnetization in the cores of electromagnets 610 decays to zero. When lid 104 is pushed toward the closed position while controllable magnet array 650 is in the OFF state and fixed magnet array 660 comes into proximity with controllable magnet array 650, the magnetic flux from fixed magnet array 660 can induce a magnetic polarization in the cores of electromagnets 610 that attracts fixed magnet array 660 without requiring any current to be applied to electromagnets 610, giving rise to the P-ATTRACT state. In some embodiments, the P-ATTRACT state can provide sufficient magnetic attraction to facilitate closing and securing lid 104 in the closed position without implementing an active ATTRACT state in controllable magnet array 650.

However, if desired, an active ATTRACT state can be used to facilitate closing of lid 104. FIG. 9 shows a flow diagram of a process 900 that controller 730 can execute in response to event signals that indicate a transition to the closed state according to some embodiments.

At block 902, controller 730 can receive an event signal (e.g., via input path 732 of FIG. 7) indicating that lid 104 is being closed. Depending on implementation and the particulars of device 100, a “Closing” event signal can be generated under various conditions. For example, a force or acceleration sensor in lid 104 can detect movement toward the closed position, or the user may operate a control (e.g., press a button, touch a particular surface, or issue a voice command) to indicate that lid 104 should be closed or that the magnetic latch should be engaged.

At block 904, controller 730 can operate driver section 702 to pulse current through each coil in controllable magnet array 650 to establish the (active) ATTRACT state of electromagnets 610. For instance, controller 730 can deliver current pulses through the coils by applying appropriate voltages on the gates of the transistors coupled to the coils, as described above. The result of block 904 can be that controllable magnet array 650 exerts an attractive force on fixed magnet array 660. Thus, lid 104 can be drawn toward or held in a closed position adjacent to (e.g., such that at least a portion of lid 104 abuts) base 102.

At block 906, controller 730 can receive an event signal (e.g., via input path 732 of FIG. 7) indicating that lid 104 is now in the closed position. Depending on implementation and the particulars of device 100, a “Closed” event signal can be generated under various conditions. For example, a contact or proximity sensor can detect when lid 104 reaches the closed position. In response to the “Closed” event signal, at block 906, controller 730 can stop operating driver section 702 so that current ceases to flow through the coils in controllable magnet array 650, and controllable magnet array 650 returns to the OFF state. It should be noted that at this point the P-ATTRACT state can arise, providing an attractive force to hold lid 104 in the closed position without additional power consumption. In some embodiments, to facilitate power conservation, the ATTRACT state can have a maximum duration, and controller 730 can proceed to block 908 when the maximum duration is reached. The maximum duration can be a design parameter and can be, e.g., 2 seconds, 5 seconds, 10 seconds, 1 minute or other duration as desired. (The maximum durations for the ATTRACT and REPEL states can be the same or different.)

It should be understood that processes 800 and 900 are illustrative and that variations and modifications are possible. In some embodiments, controller 730 can be a multi-channel controller (similar to controller 330) and can sequence the current pulses such that current pulses are supplied to the coils of different electromagnets 610 at different times. Such configurations may provide a more gradual transition into the REPEL (or ATTRACT) state and/or reduce the peak power consumption of driver section 702.

The particular event signals and order thereof are also illustrative. Any number and combination of event signals can be defined, and controller 730 can be configured (e.g., using programming or logic circuitry) to generate (or cease generating) appropriate current pulses for the state associated with a particular event. The conditions that trigger sending of event signals to controller 730 can be defined in any manner desired without departing from the scope of this disclosure.

Other variations are also possible. For example, it may be desirable to exert different amounts of attractive or repulsive force at different times. In some embodiments, this can be achieved by driving current to some but not all of electromagnets 610. For example, a “full-force” repulsion state can be defined as a state with all electromagnets 610 in the REPEL state (current pulses being applied in the appropriate direction), and a “half-force” repulsion state can be defined as a state with half of electromagnets 610 in the REPEL state (current pulses being applied in the appropriate direction) and the other half of electromagnets 610 in the OFF state (no current pulses being applied). In a similar manner, full-force attraction and half-force attraction states can also be created. Event signals to controller 730 can indicate which state should be entered, and controller 730 can generate the appropriate current pulses for a particular state in response to a particular event signal. (For instance, appropriate sequences for different states can be stored in a lookup table in association with the corresponding event signal.)

If desired, controller 730 can include an output signal path that can return information about the current state of the electromagnetic actuator system to other system components. For instance, controller 730 can send output signals indicating the state of controllable magnet array 650 (e.g., ATTRACT/REPEL/OFF) based on whether and in which direction current pulses are being applied. Such information can be used, e.g., to activate or deactivate indicator lights, to generate notification messages, to enable various security features, or the like.

### Auxiliary Magnets for Increased Torque

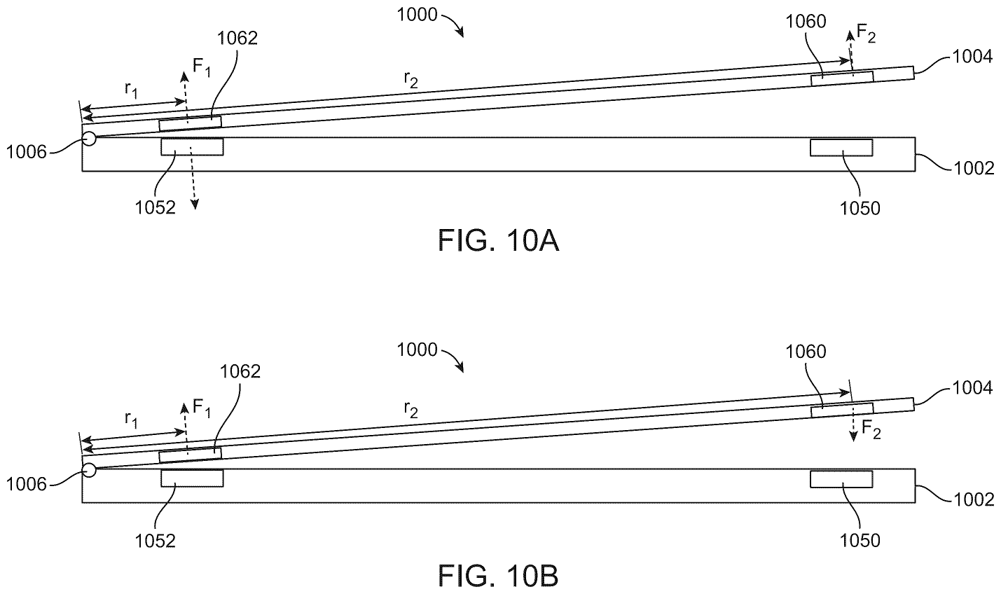

In some embodiments, a magnetic actuator system can also include additional permanent magnets, e.g., to provide increased torque in the repulsion direction. FIGS. 10A and 10B show simplified side views of a device 1000 that incorporates an electromagnetic actuator system according to some embodiments. Device 1000 can be, for example, a laptop computer having a base 1002 (which may include keyboard, trackpad, or the like) and a lid 1004 (which may include a display, camera, and the like). Base 1002 and lid 1004 can be connected by a hinge 1006, and lid 1004 can pivot on hinge 1006 between open and closed positions. As with device 100 described above, it should be understood that device 1000 can be any device that may be opened and closed, and that base 1002 and lid 1004 can correspond to any two components having opposing surfaces that are brought together (into a closed position where at least a portion of the opposing surfaces abut each other) or moved apart (into an open position). As used herein, base 1002 can be any structure that incorporates a controllable magnet array of an electromagnetic actuator system, while lid 1004 can be any structure that incorporates a fixed magnet array.

A controllable magnet array 1050 can be attached to or housed within base 1002, oriented toward interface surface 1003 of lid 1004. A fixed magnet array 1060 can be attached to or housed within lid 1004, oriented toward interface surface 1005 of base 1002. Controllable magnet array 1050 and fixed magnet array 1060 can be oriented such that they come into proximity with each other as lid 1004 moves toward the closed position. Direct contact between controllable magnet array 1050 and fixed magnet array 1060 when in the closed position is not required; however, smaller gaps between controllable magnet array 1050 and fixed magnet array 1060 correspond to increased magnetic strength (if all other factors are equal). Any intervening surfaces (e.g., a housing of base 1002 or lid 1004) should have low magnetic permeability so that flux can pass through. For instance, a plastic cover may be disposed over either or both of controllable magnet array 1050 and fixed magnet array 1060 to protect and/or conceal the magnets. Implementation and operation of controllable magnet array can be as described above with reference to controllable magnet array 150. FIG. 10A shows that when controllable magnet array 1050 is in the REPEL state, an upward force F₂ is exerted on fixed magnet array 1060. FIG. 10B shows that when controllable magnet array is in the ATTRACT state or the P-ATTRACT state, a downward force F₂ is exerted on fixed magnet array 1060. It should be understood that the magnitude of force F₂ is a function of the distance between controllable magnet array 1050 and fixed magnet array 1060; specifically, the magnitude of F₂ increases as the distance decreases and decreases as the distance increases.

Device 1000 can also include permanent magnets 1052, 1062 disposed in base 1002 and lid 1004 respectively. Permanent magnets 1052, 1062 can have opposing magnetic polarities such that permanent magnet 1052 exerts a repulsive magnetic force F₁ on permanent magnet 1062. Similarly to force F₂, the magnitude of force F₁ is a function of the distance between permanent magnet 1052 and permanent magnet 1062; specifically, the magnitude of F₁ increases as the distance decreases and decreases as the distance increases.

As shown in FIG. 10A, when controllable magnet array 1050 is in the REPEL state, forces F₁ and F₂ both act upward on lid 1004, pushing lid 1004 open. As the opening angle of lid 1004 increases, both F₁ and F₂ decrease; however, F₁ decreases more slowly than F₂ (due to the shorter distance between permanent magnets 1052, 1062 as compared to magnet arrays 1050, 1060). Thus, permanent magnets 1052, 1062 can increase the opening angle of lid 1004 that can be achieved by switching a given implementation of controllable magnet array 1050 to the REPEL state.

As shown in FIG. 10B, when controllable magnet array 1050 is in the ATTRACT state or the P-ATTRACT state, force F₁ acts upward on lid 1004 while force F₂ acts downward. At small angles, the torque due to the attractive force F₂ can exceed the torque due to the repulsive force F₁ because of the difference in distance from hinge 1006. Specifically, if r₁ is the distance from hinge 1006 to permanent magnet 1062 and r₂ is the distance from hinge 1006 to fixed magnet array 1060, then the net torque is given by τₙₑₜ=r₁F₁−r₂F₂, which can be less than zero if r₁<r₂, and lid 1004 will move to the closed position. Thus, permanent magnets positioned near a hinge can facilitate an opening action (e.g., increasing the size of the gap created between base 1002 and lid 1004) without preventing a closing action.

### Interposing Shunt

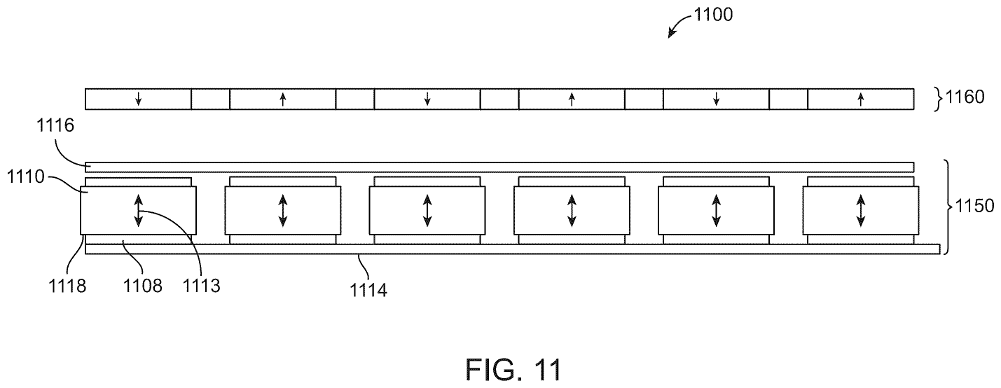

In some embodiments, a controllable magnet array for a magnetic actuator system can also include an interposing shunt that is disposed along the proximal ends of the electromagnets. FIG. 11 shows a simplified side view of an electromagnetic actuator system 1100 according to some embodiments. Electromagnetic actuator system 1100 includes a controllable magnet array 1150 and a fixed magnet array 1160. Fixed magnet array 1160 can be similar or identical to fixed magnet array 660 described above and can include an array of permanent magnets arranged to form a Halbach array. Controllable magnet array 1150 can include an array of electromagnets 1110 arranged so that their polarization is oriented in the vertical (or z) direction, as indicated by double-ended arrows 1113. Electromagnets 1110 can be similar or identical to electromagnets 610 described above. For example, each electromagnet 1110 can have a core 1108 made of a soft magnetic material, around which a coil 1118 is wrapped, and adjacent electromagnets 1110 can have their coils 1118 wound to provide alternating directions of magnetic flux as described above. (In this example, there are six electromagnets rather than the four shown in FIGS. 6A and 6B. It should be understood that any number of electromagnets can be used.) Controllable magnet array 1150 can also include a distal magnetic shunt 1114 disposed along the distal ends of electromagnets 1110. Distal magnetic shunt 1114 can be similar or identical to magnetic shunt 614 described above. Controllable magnet array 1150 can also include a proximal magnetic shunt 1116 disposed along the proximal ends of electromagnets 1110. Like distal magnetic shunt 1114, proximal magnetic shunt 1116 can be made of a soft magnetic material that acts to direct flux in a lateral direction (e.g., the x direction); examples of suitable materials include steel, iron-cobalt (FeCo), or other material.

Operation of electromagnetic actuator system 1100 can be similar or identical to operation of magnetic actuator system 600, and the control and driver circuitry can be the same as described above. That is, when current is applied to coils 1118 of electromagnets 1110 in a first direction, a repulsive magnetic force is produced between controllable magnet array 1150 and fixed magnet array 1160. When the current stops, the soft magnetic material of cores 1108 of electromagnets 1110 generally does not retain its magnetic orientation, and the repulsive force drops to zero (or near zero). Conversely, when current is applied to coils 1118 of electromagnets 1110 in a second direction (opposite to the first direction), an attractive magnetic force is produced between controllable magnet array 1150 and fixed magnet array 1160. Again, when the current stops, the soft magnetic material of cores 1108 generally does not retain its magnetic orientation, and the attractive force drops to zero (or near zero). Thus, controllable magnet array 1150 can have a “REPEL” state, an “ATTRACT” state, and an “OFF” state. In this case, the REPEL and ATTRACT states can be transitory states that persist while current is supplied, with controllable magnet array 1150 relaxing to the OFF state when current stops. In some embodiments, the current can be a pulsed current, and multiple current pulses can be supplied to maintain a REPEL or ATTRACT state.

When controllable magnet array 1150 is in the OFF state, it is possible for nearby permanent magnets to induce magnetization in the soft magnetic cores of electromagnets 1110. In particular, if fixed magnet array 1160 is in proximity to controllable magnet array 1150 while controllable magnet array 1150 is in the OFF state, the permanent magnets of the fixed magnet array can magnetize the soft magnetic cores of electromagnets 1110 such that an attractive magnetic force is created between fixed magnet array 1160 and controllable magnet array 1150. As in electromagnetic actuator system 600, this P-ATTRACT state arises passively (without supplying any current to controllable magnet array 1150) and can, for example, help to secure lid 104 in the closed position without requiring any current to be supplied to controllable magnet array 1150. In some embodiments, the P-ATTRACT state provides attractive force when desired, and an active ATTRACT state need not be implemented.

It should be understood that proximal magnetic shunt 1116 is optional. In some embodiments, proximal magnetic shunt 1116 can strengthen the field produced by electromagnets 1110 in the region proximate to fixed magnet array 1160. In one implementation, controllable magnet array 1150 produce the same repulsive force as a controllable magnet array 650 while using fewer electromagnets (e.g., five rather than seven) or reduced operating current.

It will be appreciated that electromagnetic actuator system 1100 is illustrative and that variations and modifications are possible. The dimensions and shape of the electromagnets and the number and spacing of electromagnets in a controllable magnet array can be modified as desired. In some embodiments, the electromagnets can include air-core electromagnets. (It should be noted that air-core electromagnets would not provide a passive attraction state.) For a given coil geometry and current, an air-core electromagnet generally produces a weaker magnetic field; however, eliminating the magnetic cores can reduce weight, which may be a desirable tradeoff for ultra-light devices. In some embodiments the coils of different electromagnets are connected in series (with alternating winding directions as described above). Alternatively, different electromagnets or subsets of the electromagnets can have separately driven coils. In such embodiments, the magnitude of attractive or repulsive force can be modified by driving different subsets of (or all of) the coils. Like electromagnetic actuator system 600, electromagnetic actuator system 1100 can also be used in combination with other components, such as auxiliary magnets described above.

### Additional Embodiments

While the invention has been described with reference to specific embodiments, those skilled in the art will appreciate that variations and modifications are possible. For instance, the size and/or number of the electromagnets in a controllable magnet array can be varied, and the size and number of permanent magnets in the fixed magnet arrays can be correspondingly varied. In some embodiments, multiple controllable magnet arrays can be provided in an electromagnetic actuator system, and operation of the controllable magnet arrays can be coordinated using a shared controller.

All materials described herein are illustrative, and other materials with appropriate magnetic properties (as described above) can be substituted. For instance, the magnets in a fixed magnet array can be made of hard magnetic material with high coercivity, while switchable magnets can be made of hard magnetic material with low coercivity. “High” and “low” are relative terms, and different materials can be chosen provided that changes in the magnetization of the switchable magnets have negligible (or no) effect on the magnetization of the magnets in the fixed magnet array. For instance, the high coercivity may be higher than the low coercivity by a factor of 10, 20, 30, or more. As noted above, using materials with lower coercivity (such as AlNiCo) for the switchable magnet cores reduces the amount of current required to switch the direction of magnetization as compared to using materials with higher coercivity (such as NdFeB), which can result in reduced power consumption. As another example, electromagnets can be made with cores of any soft magnetic material, or air-core electromagnets can be used.

In some embodiments, the fixed magnet array can be replaced with an appropriately shaped magnetic shunt (e.g., a piece of soft magnetic material such as steel); those skilled in the art will appreciate that where a magnetic shunt is used in place of the fixed magnet array, only attractive magnetic force would be created.

In examples described above, controllable magnet arrays and corresponding fixed magnet arrays have the magnets arranged in a straight line. Straight lines are used for clarity of illustration, and other embodiments can include magnet arrays having curved sections and/or corners. For example, electromagnets in a switchable magnetic array can be arranged along a curved line, angle, or other shape, and magnets in the corresponding fixed magnet array can be arranged to correspond to the locations of the electromagnets.

In some alternative embodiments, a fixed magnet array in an electromagnetic actuator system can be replaced by a second controllable magnet array using controllable magnets such as the switchable magnets or electromagnets described above. Control circuitry can be provided to jointly control both magnet arrays to produce desired states of ATTRACT, REPEL, and/or OFF. Using two controllable magnet arrays can reduce the use of rare earth materials, which can reduce manufacturing costs. In some embodiments, an ultra-light electromagnetic actuator system can be provided by using air-core electromagnets for both controllable magnet arrays.

Electromagnetic actuator systems of the kind described herein can be applied in any context where the ability to selectively apply attractive and/or repulsive force between a first object or surface and a second object or surface is desirable. An example of opening and closing a lid of a laptop is described above; however, many other applications are possible. Other example applications include opening and closing a door, operating a mechanical switch or relay, removably attaching one object to another (e.g., a portable device that can be held on a stand), and so on.

All processes described herein are also illustrative and can be modified. Operations can be performed in a different order from that described, to the extent that logic permits; operations described above may be omitted or combined; and operations not expressly described above may be added.

While various circuits and components are described herein with reference to particular blocks, it is to be understood that these blocks are defined for convenience of description and are not intended to imply a particular physical arrangement of component parts. The blocks need not correspond to physically distinct components, and the same physical components can be used to implement aspects of multiple blocks. Components described as dedicated or fixed-function circuits can be configured to perform operations by providing a suitable arrangement of circuit components (e.g., logic gates, registers, switches, etc.); automated design tools can be used to generate appropriate arrangements of circuit components implementing operations described herein. Components described as processors or microprocessors can be configured to perform operations described herein by providing suitable program code. Various blocks might or might not be reconfigurable depending on how the initial configuration is obtained. Embodiments of the present invention can be realized in a variety of apparatus including electronic devices implemented using a combination of circuitry and software.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It should be understood that directional terms such as “up,” “down,” “above,” “below,” and the like are used herein for simplicity of description. Such terms should be understood as distinguishing different direction in a coordinate system that can have any orientation in space.

All numerical values and ranges provided herein are illustrative and may be modified. Unless otherwise indicated, drawings should be understood as schematic and not to scale.

Accordingly, although the invention has been described with respect to specific embodiments, it will be appreciated that the invention is intended to cover all modifications and equivalents within the scope of the following claims.

What is claimed is:

1. An electromagnetic actuator system comprising:
a fixed magnet array comprising an array of first permanent magnets arranged parallel to an interface surface and having fixed magnetic polarizations in alternating directions toward or away from the interface surface;
a controllable magnet array comprising a plurality of electromagnets, wherein each electromagnet comprises a core made of a soft magnetic material and a coil of wire wound around the core, wherein each electromagnet of the plurality of electromagnets is positioned in alignment with a corresponding one of the first permanent magnets; and
a control and driver circuit coupled to the coils and configured to supply current pulses to the coils in a first direction, thereby producing a first state of the controllable magnet array in which a direction of magnetic polarization of each electromagnet is antiparallel to the magnetic polarization of the corresponding one of the first permanent magnets, creating magnetic repulsion between the fixed magnet array and the controllable magnet array that persists while current pulses continue to be supplied.

2. The electromagnetic actuator system of claim 1 wherein the control and driver circuit is further configured to supply current pulses to the coils in a second direction opposite the first direction, thereby producing a second state of the controllable magnet array in which the direction of magnetic polarization of each electromagnet is parallel to the magnetic polarization of the corresponding one of the first permanent magnets, creating magnetic attraction between the fixed magnet array and the controllable magnet array.

3. The electromagnetic actuator system of claim 1 wherein the control and driver circuit is configured to supply current pulses to different coils independently of each other.

4. The electromagnetic actuator system of claim 3 wherein the control and driver circuit is further configured to modify a magnitude of a magnetic force between the fixed magnet array and the controllable magnet array by supplying current pulses to a subset of the electromagnets.

5. The electromagnetic actuator system of claim 1 wherein the control and driver circuit includes gating circuitry to prevent ringing in the coils following a current pulse.

6. The electromagnetic actuator system of claim 1 wherein the soft magnetic material of the cores of the electromagnets comprises magnetic steel.

7. The electromagnetic actuator system of claim 1 wherein, when the control and driver circuit is not supplying current and the fixed magnet array is in proximity to the controllable magnet array, a magnetic attraction is created between the cores of the electromagnets and the first permanent magnets of the fixed magnet array.

8. The electromagnetic actuator system of claim 1 wherein the fixed magnet array further includes a plurality of second permanent magnets, each second permanent magnet disposed between adjacent first permanent magnets, the second permanent magnets having magnetic polarity oriented in a lateral direction and wherein the electromagnets are spaced apart according to a spacing of the first permanent magnets.

9. The electromagnetic actuator system of claim 1 wherein the fixed magnet array further includes a shunt plate disposed on a distal side of the first permanent magnets.

10. The electromagnetic actuator system of claim 1 wherein the controllable magnet array further includes a first shunt plate disposed on a distal side of the electromagnets.

11. The electromagnetic actuator system of claim 10 wherein the controllable magnet array further includes a second shunt plate disposed on a proximal side of the electromagnets.

12. A device comprising:
a first object having a first interface surface, the first object including a controllable magnet array comprising a plurality of electromagnets arranged proximate to the first interface surface, wherein each electromagnet comprises:
a core defining an axis, the core being made of a soft magnetic material; and
a coil of wire wound around the core along the axis of the core;
a second object having a second interface surface, the second object being positionable relative to the first object such that the second interface surface abuts the first interface surface,
the second object including a fixed magnet array comprising an array of first permanent magnets arranged proximate to the second interface surface such that each first permanent magnet aligns with a corresponding one of the electromagnets of the controllable magnet array, wherein alternating first permanent magnets have fixed magnetic polarizations in opposite directions toward or away from the interface surface; and
a control and driver circuit coupled to the coils of the electromagnets and configured to supply current pulses to the coils such that supplying current pulses in a first direction produces a first state of the controllable magnet array in which a direction of magnetic polarization of each electromagnet is antiparallel to the magnetic polarization of the corresponding one of the first permanent magnets, creating a repulsive magnetic force between the fixed magnet array and the controllable magnet array that persists while current pulses continue to be supplied.

13. The device of claim 12 wherein the fixed magnet array further includes a plurality of second permanent magnets, each second permanent magnet disposed between adjacent first permanent magnets, the second permanent magnets having magnetic polarity oriented in a lateral direction and wherein the electromagnets are spaced apart according to a spacing of the first permanent magnets.

14. The device of claim 12 wherein the control and driver circuit is disposed within the first object.

15. The device of claim 12 wherein the first object is a base that includes a keyboard oriented toward the first interface surface and the second object is a lid that includes display oriented toward the second interface surface, and wherein the first object and the second object are connected by a hinge such that rotational movement of the first object or the second object about the hinge moves the first and second interface surfaces toward or away from each other.

16. The device of claim 15 wherein the first permanent magnets and the electromagnets are sized and shaped such that when the controllable magnet array is in the first state, the repulsive magnetic force between the fixed magnet array and the controllable magnet array creates a gap between the lid and the base.

17. The device of claim 16 wherein the control and driver circuit is further configured such that:
the control and driver circuit begins supplying current pulses to produce the first state of the controllable magnet array in response to receiving a release event signal; and
the control and driver circuit ceases supplying current pulses in response to receiving an open event signal following the release event signal or after a maximum duration has passed.

18. The device of claim 17 wherein the control and driver circuit is further configured to supply current pulses to the coils in a second direction opposite the first direction, thereby producing a second state of the controllable magnet array in which the direction of magnetic polarization of each electromagnet is parallel to the magnetic polarization of the corresponding one of the first permanent magnets, creating magnetic attraction between the fixed magnet array and the controllable magnet array.

19. The device of claim 18 wherein the control and driver circuit is further configured such that:
the control and driver circuit begins supplying current pulses to produce the second state of the controllable magnet array in response to receiving a closing event signal; and
the control and driver circuit ceases supplying current pulses in response to receiving an closed event signal following the closing event signal or after the maximum duration has passed.

20. An electromagnetic actuator system comprising:
a fixed magnet array comprising an array of first permanent magnets arranged parallel to an interface surface and having fixed magnetic polarizations in alternating directions toward or away from the interface surface;
a controllable magnet array comprising a plurality of switchable permanent magnets, wherein each of the switchable permanent magnets comprises a core made of a hard magnetic material and a coil of wire wound around the core along a transverse axis of the core, wherein each of the switchable permanent magnets is positioned in alignment with a corresponding one of the first permanent magnets; and
a control and driver circuit coupled to the coils and configured to supply current pulses to the coils to change a magnetic polarization state of the cores of the switchable permanent magnets, thereby switching the switchable permanent magnets among a plurality of states,
the plurality of states including a first state in which a direction of magnetic polarization of the core of each switchable permanent magnet is parallel to the magnetic polarization of the corresponding one of the first permanent magnets, a second state in which the direction of magnetic polarization of the core of each switchable permanent magnet is antiparallel to the magnetic polarization of the corresponding one of the first permanent magnets, and a third state in which the core of each switchable permanent magnet is demagnetized.
